(19) United States
(12) Patent Application Publication
(10) Pub. No.: US 2004/0258570 A1
(43) Pub. Date: Dec. 23, 2004

(54) Biochemical signal transfer using liposomes in a channel of a microfluidic device

(76) Inventors: David J. Beebe, Monona, WI (US); Jung-Hwa Aura Gimm, Madison, WI (US); Arnold E. Ruoho, Madison, WI (US); Jeffrey S. Moore, Savoy, IL (US)

Correspondence Address: Peter C. Stomma, BOYLE. FREDRICKSON, NEWHOLM, STEIN & GRATZ S.C., Suite 1030, 250 E. Wisconsin Avenue, Milwaukee, WI, 53202, US

(21) Appl. No.: 10/701,250

(22) Filed: Nov. 4, 2003

Related U.S. Application Data
(60) Provisional application No. 60/423,544, filed on Nov. 4, 2002.

(51) Int. Cl. B01L 3/00

(52) U.S. Cl. 422/100

(57) ABSTRACT

An integrated biological microfluidic system and method of using the same is provided. The microfluidic system includes a microfluidic device having a channel therethrough. A filter and a vesicle containing a predetermined cargo are positioned in the channel. The vesicle has outer surface carrying a bioactive molecule. A reagent having predetermined stimuli therein flows through the channel and carries the vesicle to the filter. If the bioactive molecule is activated by the predetermined stimuli, lysis of the vesicle is triggered, thereby releasing the cargo. The cargo flows through the filter and engages a visual detection structure positioned in the channel downstream of the filter. The visual detection structure provides a visual display in response to exposure to the cargo.

### CROSS-REFERENCE TO RELATED APPLICATIONS

This application claims the benefit of U.S. Provisional Application Ser. No. 60/423,544, filed Nov. 4, 2002.

### REFERENCE TO GOVERNMENT GRANT

This invention was made with United States government support awarded by the following agencies: DOD ARPA F30602-00-2-0570. The United States has certain rights in this invention.

### FIELD OF THE INVENTION

This invention relates generally to microfluidic devices, and in particular, to an integrated biological microfluidic system wherein upstream biochemical stimuli can be relayed and amplified for visual detection downstream.

### BACKGROUND AND SUMMARY OF THE INVENTION

Biochemical detection systems that mimic the complement system in the human body are used for a wide variety of applications. As is known, the complement system plays an essential role in the human body's defense against infectious agents and in the inflammatory process. More specifically, the complement system comprises a set of proteins that is designed to eliminate foreign microorganisms and other antigens from tissues and blood. By way of example, when pathogenic antigens are detected and bound by free antibodies in the blood, the set of proteins or complement is recruited to the site. This event triggers what is known as a complement cascade. The complement cascade is a multi-step process wherein holes are drilled into the membrane of the pathogen thereby lysing and destroying the cell.

In current biochemical detection systems, artificially created biological elements such as liposomes may be used to trigger a complement cascade in test tubes. A liposome is an artificially created microscopic vesicle that consists of an aqueous core enclosed in one or more phospholipid layers. It has been commonly used as a device to convey an encapsulated cargo, such as vaccines, drugs, enzymes, or DNA to a target cell or organ. Liposomes can be easily functionalized by attaching specific antigenic molecules to the outer surfaces of the liposomes and depositing the liposomes in a bulk solution containing predetermined antibodies. If the antibodies present in the bulk solution bind to the antigens attached to the outer surfaces of the liposomes, a complement cascade will be triggered. As a result, lysing will occur so as to cause the liposomes to unload their encapsulated cargo. Lysis and unloading of liposome cargo will only occur when the antigens on the outer surfaces of the liposomes detect their target antibody in the bulk solution. The encapsulated cargo released into the bulk solution is then measured to determine the magnitude of the lysing effect.

It can be appreciated that the process to determine the lysing effect is somewhat inefficient. For example, a large volume of reagent may be required to conduct the process. Since the production of sufficient volumes of the reagent is often time consuming, as well as, expensive, it is highly desirable to provide a method of performing the process utilizing smaller volumes of reagents than prior methods. Further, the process for determining the lysing effect in biochemical detection systems may take a long period of time. Therefore, a biochemical detection system that performs the process more quickly than present systems is highly desirable.

Therefore, it is a primary object and feature of the present invention to provide an integrated biological microfluidic system wherein upstream biochemical stimuli can be relayed and amplified for visual detection downstream.

It is a further object and feature of the present invention to provide a method of relaying and amplifying an initial biochemical signal in a microfluidic device for visual detection downstream.

It is a still further object and feature of the present invention to provide a method of relaying and amplifying an initial biochemical signal in a microfluidic device that is simpler and less expensive than prior methods.

It is a still further object and feature of the present invention to provide a method of relaying and amplifying an initial biochemical signal in a microfluidic device that is more efficient than prior methods.

In accordance with the present invention, a microfluidic device is provided. The microfluidic device includes a channel therethrough having upstream and downstream ends and is adapted for receiving a vesicle. The vesicle contains predetermined cargo therein and has an outer surface carrying a bioactive molecule. The microfluidic device also includes a filter positioned within the channel. The filter has pores of predetermined sizes that prevents the vesicle from flowing downstream of the filter and that allows the cargo to flow downstream through the filter. A visual detection structure is positioned in the channel downstream of the filter. The visual detection structure provides a visual display in response to exposure to the cargo.

The visual detection structure may include a first post that dissolves in response to exposure to the cargo and a second post that is non-responsive to exposure to the cargo. The first post may be formed from polyacrylamide and dissolvable disulfide crosslinkers. A reagent is receivable in the channel. The reagent is flowable from the upstream end to the downstream end of the channel. The reagent includes predetermined stimuli therein.

In accordance with a further aspect of the present invention, a method is provided for relaying and amplifying an initial biochemical signal in a microfluidic device. The method includes the step of encapsulating cargo within a vesicle having an outer surface. A bioactive molecule is implanted in the outer surface of the vesicle and the vesicle is exposed to a reagent. The cargo is released from the vesicle in response to predetermined stimuli in the reagent and is passed through a filter. A visual display is generated in response to the release of the cargo.

The method may include the additional step of providing a microfluidic device having a channel therein such that the vesicle is exposed to the reagent in the channel of the microfluidic device. A filter is positioned in the channel for capturing the vesicle upstream thereof and a visual display is positioned in the channel downstream of the filter. The visual display includes a responsive post that dissolves in response to exposure to the cargo and a non-responsive post that maintains its configuration in response to exposure to the cargo.

It is contemplated for the vesicle to be a liposome and for the bioactive molecule carried by the outer surface of the vesicle to be an antigen. The predetermined stimuli in the reagent include an antibody and a set of proteins. As such, if the antibody present in the reagent bind to the antigen carried by the outer surface of the liposome, a complement cascade will be triggered. As a result, lysing will occur so as to cause the liposome to unload its encapsulated cargo.

In accordance with a still further aspect of the present invention, a method is provided for relaying and amplifying an initial biochemical signal in a microfluidic device. The method includes the steps of positioning a vesicle in the upstream end of the channel and exposing the vesicle to a reagent. The vesicle contains a predetermined cargo therein and has an outer surface carrying a bioactive molecule. The cargo is released from the vesicle in response to predetermined stimuli in the reagent binding to the bioactive molecule. A visual display is generated in the channel downstream of the vesicle in response to the release of the cargo.

A filter may be positioned in the channel for capturing the vesicle upstream thereof and a visual display may be positioned in the channel downstream of the filter. The visual display includes a responsive post that dissolves in response to exposure to the cargo and a non-responsive post that maintains its configuration in response to exposure to the cargo.

It is contemplated for the vesicle to be a liposome and for the bioactive molecule carried by the outer surface of the vesicle to be an antigen. The predetermined stimuli in the reagent include an antibody and a set of proteins. As such, if the antibody present in the reagent bind to the antigen carried by the outer surface of the liposome, a complement cascade will be triggered. As a result, lysing will occur so as to cause the liposome to unload its encapsulated cargo.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is a schematic view of a microfluidic device for use in the integrated biological microfluidic system of the present invention;

FIG. 2a is a schematic view of an initial set of steps conducted in the integrated biological microfluidic system of the present invention;

FIG. 2b is a schematic view of an additional step conducted in the integrated biological microfluidic system of the present invention;

FIG. 2c is a schematic view of additional set of steps conducted in the integrated biological microfluidic system of the present invention;

FIG. 3 is a cross-sectional view of the microfluidic device taken along line 3-3 of FIG. 2c; and

FIG. 4 is a cross-sectional view of the microfluidic device taken along line 4-4 of FIG. 2c.

### DETAILED DESCRIPTION OF THE DRAWINGS

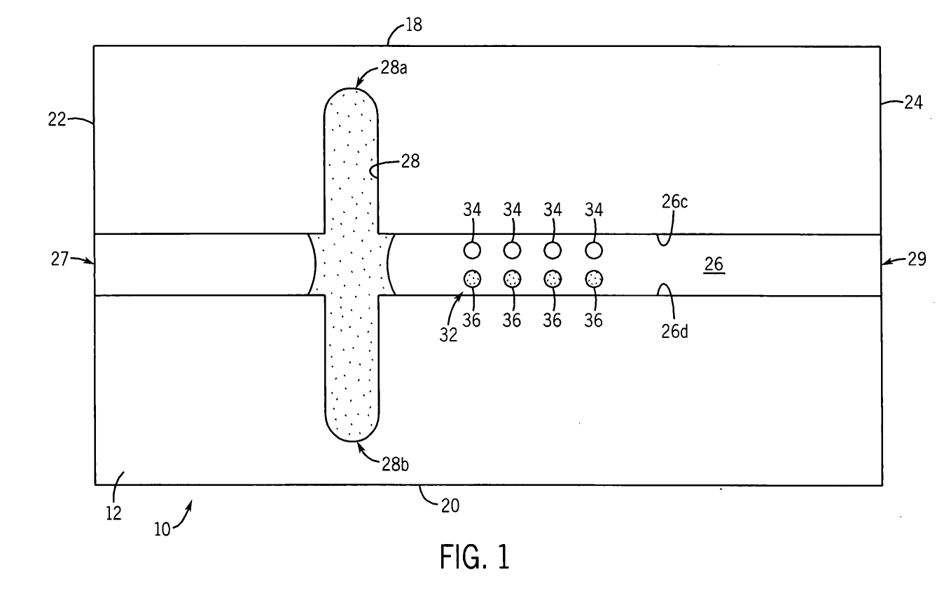

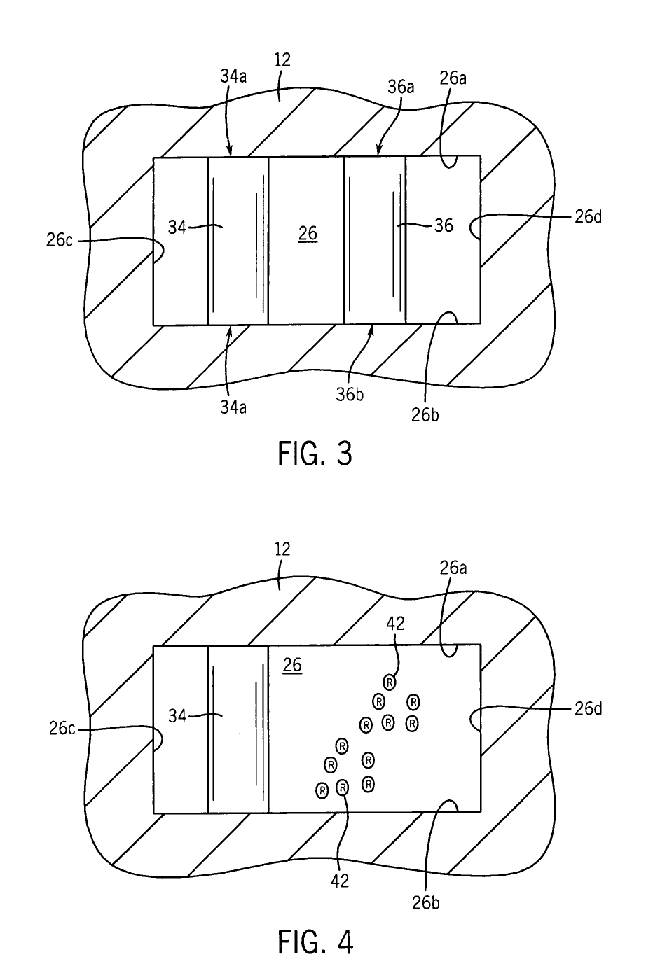

Referring to FIG. 1, a microfluidic device is generally designated by the reference numeral 10. Microfluidic device 10 includes body 12 having first and second sides 18 and 20, respectively, and by first and second ends 22 and 24, respectively. First channel 26 extends longitudinally through body 12 between first and second ends 22 and 24, respectively, thereof, and includes an input 27 and an output 29 for accommodating the flow of fluid through microfluidic device 10. As best seen in FIGS. 3 and 4, first channel 26 is defined by upper and lower walls 26a and 26b, respectively, and side walls 26c and 26d formed within body 12 of microfluidic device 10.

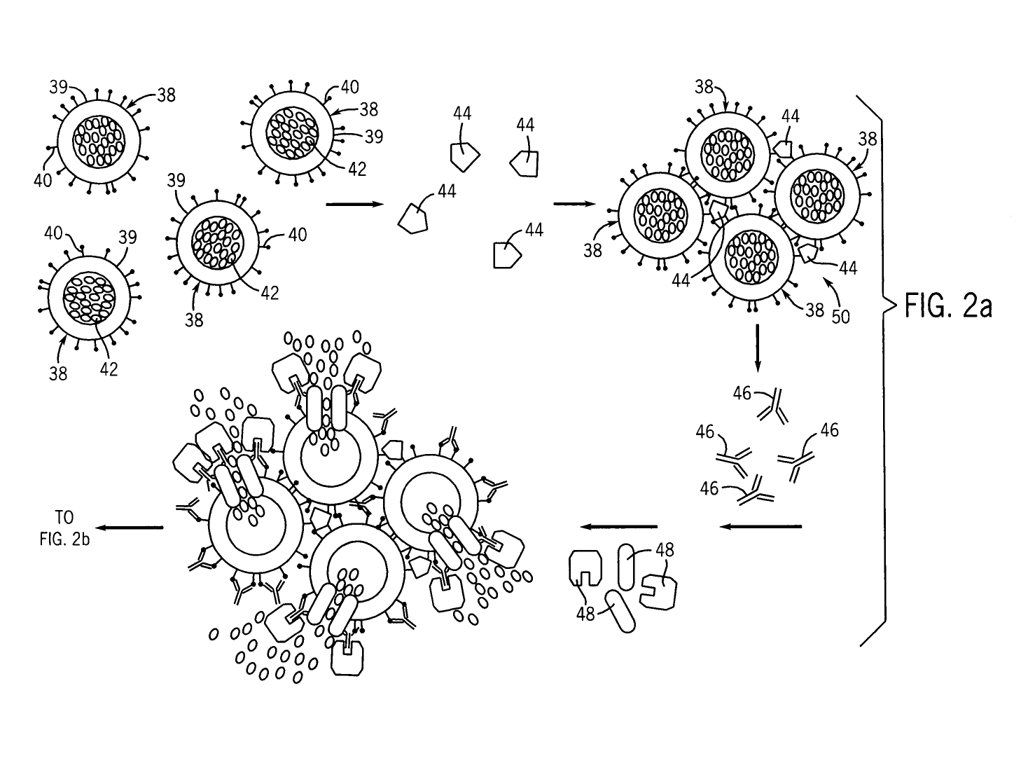

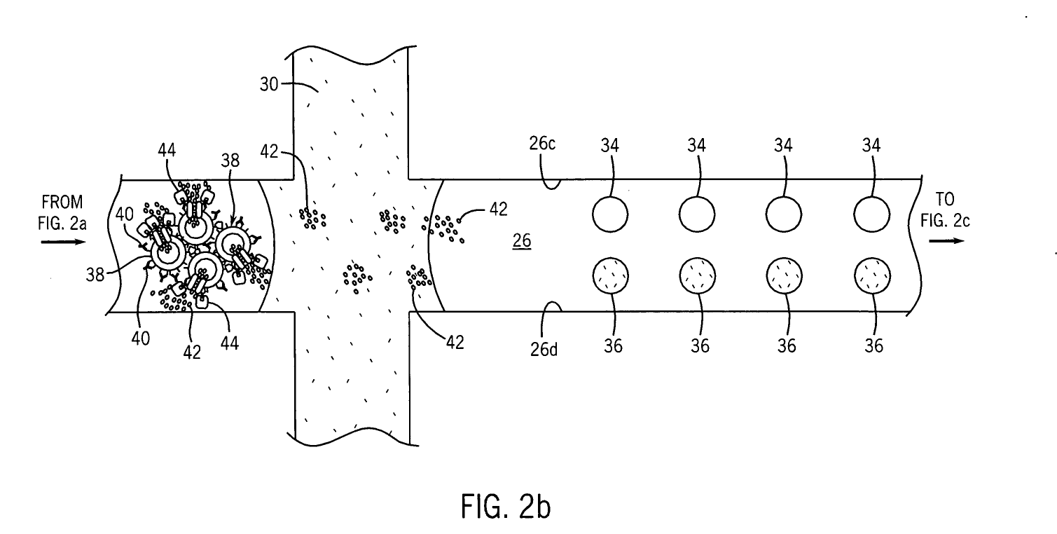

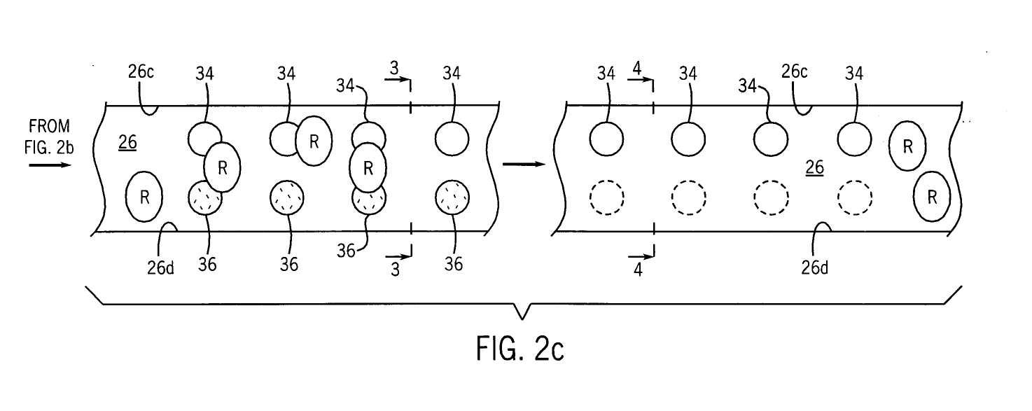

Body 12 also includes second channel 28 that is transverse to and communicates with first channel 26. Second channel 28 includes a first closed end 28a that is spaced from first side 18 of body 12 and a second closed end 28b that is spaced from second side 20 of body 12. Referring to FIGS. 1 and 2b, a flow constriction or filter 30 is fabricated within second channel 28 from a pre-polymer mixture injected therein. Filter 30 is fabricated by phase separation photo-polymerization of the pre-polymer mixture. In such process, the pre-polymer mixture includes a monomer, a porogen (e.g. water, salts), a cross-linker and a photoinitiator. Two immiscible phases are agitated to create droplets of a first phase suspended in a second phase. Photo-polymerization of one phase results in the formation of polymer particles that subsequently join together. Upon further processing (e.g. drying to remove water), the porogen is removed to give a contiguous polymer particle network surrounded by interconnected passageways or, in other words, filter 30. The size, distribution of the passageways, and the mechanical properties of filter 30 are dependent on a number of factors including monomer and water concentration, the cross-linkers utilized and the photoinitiator concentration. This, in turn, allows for a user to fine tune the filtering properties of filter 30 for various applications.

Fabricating filter 30 by phase separation photo-polymerization of the pre-polymer mixture allows filter 30 to have multiple tortuous passageways therethrough. As such, filter 30 within second channel 28 has the ability to filter particles flowing through first channel 26 based on size. In addition, filter 30 in second channel 28 has the ability to hold objects or particles within first channel 26 at a user desired location. By choosing an appropriate composition of monomer, cross-linker, photoinitiator and porogen for filter 30, the size of the passageways (less than 1 μm to 150 μm) and the distribution thereof in filter 30 can be modified as desired by a user.

Microfluidic device 10 further includes a visual detection system generally designated by the reference numeral 32. For reasons hereinafter described, it is intended that visual detection system 32 provide a visual display to a user in response to exposure of visual detection system 32 to a predetermined chemical or biochemical stimuli. By way of example, visual detection system 32 includes a plurality of longitudinally spaced, non-responsive posts 34 positioned in first channel 26 downstream of filter 30. As best seen in FIGS. 3 and 4, each non-responsive post 34 has an upper end 34a operatively connected to upper wall 26a of first channel 26 and a lower end 34b operatively connected to lower wall 26b of first channel 26. In addition, visual detection system 32 includes a plurality of longitudinally spaced, responsive posts 36 positioned in first channel 26 downstream of filter 30. As best seen in FIGS. 1 and 2b-4, each responsive post 36 is aligned with a corresponding non-responsive post 34 and includes an upper end 36a operatively connected to upper wall 26a of first channel 26 and a lower end 36b operatively connected to lower wall 26b of first channel 26.

Referring to FIGS. 2a-2c, in operation, vesicles such as liposomes 38 are artificially created. As is known, outer surface 39 of liposomes 38 provide a natural environment for immobilization of bioactive molecules such as antigens 40. In addition, liposomes 38 encapsulate a plurality of molecules 42 that act as a secondary messenger, as hereinafter described, to relay a biochemical signal downstream within first channel 26 of microfluidic device 10. Liposomes 38 are incubated with agglutination agents 44 to form a liposome complex 50 that, in turn, are injected into input 27 of first channel 28 along with a reagent solution containing antibodies 46 and a set of proteins 48. Agglutination agents 44 bind to antigens 40 of liposomes 38 and cause aggregation of the same. The aggregated liposomes 38 form liposome complex 50 of sufficient dimension to be captured by filter 30. However, it is preferred that the pores or passageways through filter 30 be small enough to capture non-aggregated liposomes 38.

If antibodies 46 in the reagent solution bind to antigens 40 attached to outer surfaces 39 of liposomes 38, the set of proteins 48 in the reagent solution is recruited to the site such that a complement cascade is triggered. As a result, lysing will occur so as to cause liposomes 38 to unload their encapsulated cargo, namely, molecules 42. Lysis and the unloading of molecules 42 will only occur when antigens 40 on outer surfaces 39 of liposomes 38 detect target antibodies 46 in the reagent solution.

Referring to FIG. 2b, after molecules 42 are unloaded from liposomes 38, molecules 42 (being smaller in size than the passageways in filter 30) continue to flow downstream through the pores and passageways in filter 30. Once molecules 42 are downstream of filter 30, molecules 42 flow to and engage non-responsive and responsive posts 34 and 36, respectively, of visual detection system 32, as represented in FIG. 2c. By way of example, it is contemplated that molecules 42 dissolve responsive posts 36 in order to provide a user with a visually detectable signal in response to the biochemical stimuli occurring upstream. Thereafter, molecules 42 continue to flow downstream though output 29 of first channel 26.

In a contemplated embodiment, non-responsive posts 34 are fabricated by injecting polyacrylamide into first channel 26 and polymerizing non-responsive posts 34 at a location heretofore described. Responsive posts 36 are fabricated by injecting polyacrylamide having dissolvable disulfide crosslinkers into first channel 26 and polymerizing responsive posts 36 with a cleavable crosslinker N,N′-cystaminebisacrylamide at a location heretofore described. Liposomes 38 may be prepared following a standard protocol for small unilamellar vesicles using phospholipid mixtures with traces of fluorescent and biotinylated lipids (biotin) 40 for functionalization and for visualization, respectively. Liposomes 38 may be prepared in the presence of TCEP-HCl (tris-(2-carboxyethyl) phosphine hydrochloride) to encapsulate molecules 42 such as a reducing agent.

The purified TCEP-HCI-encapsulated liposomes 38 are incubated with an agglutination agent 44 such as avidin to form liposome complexes 50. Avidin, by binding to the biotin on liposome surfaces 39, causes aggregation of liposomes 38, thereby effectively increasing the liposome size. The binding of the avidin to liposomes 38 has two significant effects. First, it demonstrates functionalization of outer surfaces 39 of liposomes 38 where the biotinylated lipids were used to bind the avidin. Further, the larger size of liposome complexes 50 allow for the more efficient capture of liposome complexes 50 by filter 30.

The liposome complexes and the reagent solution containing a detergent (10% triton-X) or the bee venom peptide melittin (1-10 mM) are injected into input 27 of first channel 26 so as to solubilize the liposome complexes, thereby unloading the encapsulated TCEP-HCl. As a result, molecules 42 are free to flow downstream through filter 30 into contact with non-responsive and responsive posts 34 and 36, respectively. Molecules 42 reduce disulfide (S—S) bonds in responsive posts 36. The reduction of disulfide crosslinkers in responsive posts 36 causes their dissolution that can be visually detected, as heretofore described. Complete dissolution of responsive posts 36 takes place in minutes, leaving only non-responsive posts 34 in first channel 26 in body 12 of microfluidic device 10.

It can be appreciated that the biochemical detection system of the present invention allows for the encapsulation of a specific chemical in liposomes that, upon release, causes a visible secondary reaction downstream. As such, great numbers of potential uses for the biochemical detection system are contemplated. For example, if it is necessary to detect specific antibodies in a blood sample, both the detection and signal amplification can be triggered by the sample requiring no other reagents since the complement proteins are present in blood serum. Further, the system of the present invention can be easily modified to detect different antibodies. In addition, since biochemical detection system of the present invention is conducted on the microscale, the volume of reagent and the amount of time necessary to determine the lysing effect are significantly less than the volume of reagent and amount of time necessary in prior biochemical detection systems.

Various modes of carrying out the invention are contemplated as being within the scope of the following claims particularly pointing out and distinctly claiming the subject matter that is regarded as the invention.

We claim:

1. A microfluidic device including a channel therethrough having upstream and downstream ends and being adapted for receiving a vesicle, the vesicle containing predetermined cargo therein and having an outer surface carrying a bioactive molecule, the microfluidic device comprising:
a suspension structure positioned within the channel for retaining the vesicle at a selected location within the channel; and
a detection structure positioned in the channel downstream of the suspension structure, the detection structure providing a reaction in response to exposure to the cargo.

2. The microfluidic device of claim 1 wherein the detection structure includes a first post that dissolves in response to exposure to the cargo.

3. The microfluidic device of claim 2 wherein the detection structure display includes a second post that is non-responsive to exposure to the cargo.

4. The microfluidic device of claim 2 wherein the first post is formed from polyacrylamide and dissolvable disulfide crosslinkers.

5. The microfluidic device of claim 1 further comprising a reagent receivable in the channel, the reagent flowable from the upstream end to the downstream end of the channel.

6. The microfluidic device of claim 1 wherein the reagent includes predetermined stimuli therein, the predetermined stimuli reacting with the bioactive molecule to free the cargo from the vesicle.

7. The microfluidic device of claim 1 wherein the suspension structure includes a filter having a predetermined pore size, the pore size being of a dimension that prevents the vesicle from flowing downstream of the filter and that allows the cargo to flow downstream through the filter.

8. A method of relaying and amplifying an initial biochemical signal in a microfluidic device, comprising the steps of:
encapsulating cargo within a vesicle, the vesicle having an outer surface;
implanting a bioactive molecule in the outer surface of the vesicle;
exposing the vesicle to a reagent;
releasing the cargo from the vesicle in response to predetermined stimuli in the reagent; and
generating a reaction display in response to the release of the cargo.

9. The method of claim 8 comprising the additional step of providing a microfluidic device having a channel therein and wherein the step of exposing the vesicle to the reagent occurs in the channel of the microfluidic device.

10. The method of claim 8 comprising the additional step of passing the cargo through a filter.

11. The method of claim 10 comprising the additional step of positioning the filter in the channel for capturing the vesicle upstream thereof.

12. The method of claim 11 wherein the step of generating a reaction includes the step of positioning a visual display in the channel downstream of the filter.

13. The method of claim 12 wherein the visual display includes a responsive post that dissolves in response to exposure to the cargo.

14. The method of claim 13 wherein the step of generating a reaction includes the additional step of dissolving the responsive post.

15. The method of claim 13 wherein the visual display includes a non-responsive post having a configuration, the configuration of the non-responsive post maintained in response to exposure to the cargo.

16. The method of claim 8 wherein the vesicle is a liposome.

17. The method of claim 8 wherein the bioactive molecule is an antigen.

18. The method of claim 8 wherein the predetermined stimuli include an antibody and a set of proteins.

19. A method of relaying and amplifying an initial biochemical signal in a microfluidic device, comprising the steps of:
positioning a vesicle in the upstream end of the channel, the vesicle containing predetermined cargo therein and having an outer surface carrying a bioactive molecule;
exposing the vesicle to a regent;
releasing the cargo from the vesicle in response to predetermined stimuli in the reagent binding to the bioactive molecule; and
generating a reaction in the channel downstream of the vesicle in response to the release of the cargo.

20. The method of claim 19 comprising the additional step of positioning a filter in the channel for capturing the vesicle upstream thereof.

21. The method of claim 20 wherein the step of generating a reaction includes the additional step of positioning a visual display in the channel downstream of the filter.

22. The method of claim 21 wherein the visual display includes a responsive post that dissolves in response to exposure to the cargo.

23. The method of claim 22 wherein the step of generating a reaction includes the additional step of dissolving the responsive post.

24. The method of claim 23 wherein the visual display includes a non-responsive post having a configuration, the configuration of the non-responsive post maintained in response to exposure to the cargo.

25. The method of claim 19 wherein the vesicle is a liposome.

26. The method of claim 19 wherein the bioactive molecule is an antigen.

27. The method of claim 19 wherein the predetermined stimuli include an antibody and a set of proteins.
